(19) United States
(12) Patent Application Publication
(10) Pub. No.: US 2005/0091356 A1
(43) Pub. Date: Apr. 28, 2005

(54) Method and machine-readable medium for using matrices to automatically analyze network events and objects

(76) Inventor: Matthew Izzo, South Plainfield, NJ (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/691,619

(22) Filed: Oct. 24, 2003

(51) Int. Cl. G06F 15/173

(52) U.S. Cl. 709/223

(57) ABSTRACT

A method and machine-readable medium for automatically analyzing network events using matrices is described. The method and machine-readable medium include choosing the focal event or object, optionally filtering events, generating and populating an object topology matrix or an event topology matrix, evaluating event vectors, analyzing the matrix according to one of several protocols, optionally displaying the results on a user interface, and optionally applying rules or policies to the analysis, if required.

### BACKGROUND OF THE INVENTION

1. Field of the Invention

The present invention is related to computer network administration. More specifically, the present invention is related to automated, topology-based network event analysis in the maintenance of networks and services.

2. Description of the Related Art

For telecommunications service providers, service assurance comprises the set of processes, systems, and functions used to maintain the health of network resources, and the quality of the services provided over them. Much of this involves the analysis of alarms, events, and other data gathered from the network. Unfortunately, much of this tedious work is either performed manually or with limited support from operations support systems (OSSs).

Telecommunications service providers today employ a large variety of OSSs to help filter, correlate, display, and otherwise process network and service events. However, most automated systems only provide a basic level of event analysis. If supported at all, detailed analysis, e.g., determining root cause, is performed with limited automation, typically by using heuristic rule sets. The complexity and maintenance costs of these solutions are often not worth the benefits thereof over manual troubleshooting.

Service providers look to event/alarm analysis to answer several important questions, including: (a) what services and customers are affected by a network event, alarm, or trouble; (b) what is the root cause of the trouble; (c) how can the network/service operations centers (those departments that receive and process network and service events) reduce, correlate, and prioritize events and alarms into a workable number; and (d) where should field repair services be dispatched, and how can this be done more cost-effectively?

In various attempts to address the above issues, OSS providers have increasingly tried to automate the event analysis process. This is typically accomplished via basic alarm filtering and correlation rules. Advanced event analysis often uses hard-coded logic or rule sets to define how specific events on specific resources should be handled. Given the large number of applicable events and network resources, this method requires significant effort to develop and maintain the event handling logic.

More recently, network/resource topology information, i.e., computer models of the interconnection of network and service resources, has been used to facilitate automated event analysis, particularly for root cause determination. These methods correlate network events and the resources on which the events are reported. The methods typically use rules or policies to determine what services or customers are affected by the events, how multiple sympathetic events can be intelligently reduced, and what the root cause of the event might be (in the case of a failure). Common root cause analysis algorithms identify the earliest occurring alarm/event within a timeframe, or the most upstream failure on a communications link.

Another type of event analysis, claimed by SMARTS, involves building codebooks that use alarm pattern matching on events to determine the root cause. The codebooks are derived from the network topology, and must be updated each time the topology changes. Because large networks are constantly changing, keeping the codebooks current or adding new types of patterns can be challenging. Furthermore, deriving the dependency patterns could be difficult for more complex networks, such as those found in large tier-1 service providers.

### SUMMARY OF THE INVENTION

A method and machine-readable medium for automatically analyzing network events using matrices is described. The method and machine-readable medium include choosing the focal event or object, optionally filtering events, generating and populating an object topology matrix or an event topology matrix, evaluating event vectors, analyzing the matrix according to one of several protocols, optionally displaying the results on a user interface, and optionally applying rules or policies to the analysis, if required.

### BRIEF DESCRIPTION OF THE DRAWINGS

In the drawings:

FIG. 1 is a diagram illustrating an example of a resource topology;

FIG. 2 is a diagram illustrating an example of an object topology matrix according to the resource topology of FIG. 1;

FIG. 3 is a diagram illustrating the resource topology of FIG. 1, overlayed with various events;

FIG. 4 is a diagram illustrating an example of an event topology matrix according to the resource topology and events of FIG. 3;

FIG. 5 is a flowchart illustrating a method and machine-readable medium for automatically analyzing network events using matrices, according to embodiments of the present invention;

FIG. 6 is a diagram illustrating a display of network events on a GUI, according to embodiments of the present invention;

FIG. 7 is a diagram illustrating a display of the network events of FIG. 3 on a GUI, according to embodiments of the present invention; and

FIG. 8 is a diagram illustrating another display of the network events of FIG. 3 on a GUI, according to embodiments of the present invention.

### DETAILED DESCRIPTION OF THE PREFERRED EMBODIMENTS

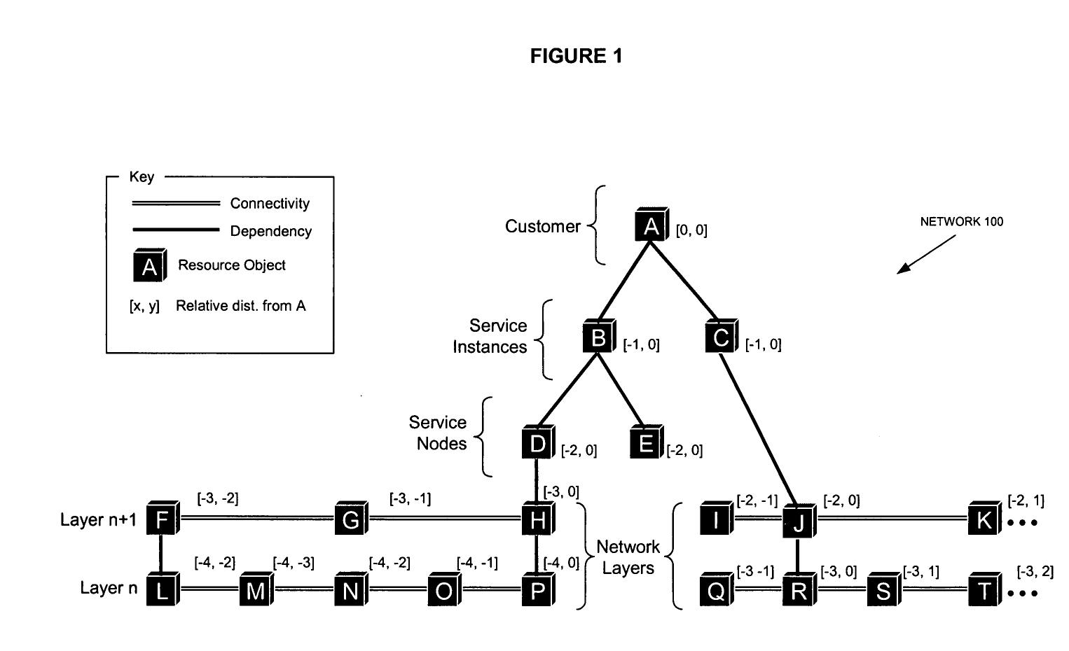

Embodiments of the invention may be best understood by referring to the following description and accompanying drawings that illustrate such embodiments. The numbering scheme for the Figures included herein are such that the leading number for a given element in a Figure is associated with the number of the Figure. For example, network 100 can be located in FIG. 1. However, element numbers are the same for those elements that are the same across different Figures.

To resolve the above-described issues, the present invention involves a topology model with an automated method of topology and event analysis. The solution is intended to help service providers identify impacted services and customers; identify and prioritize suspected root cause events/alarms, correlate and suppress sympathetic events/alarms (those events/alarms other than the root cause suspects), and localize event/alarm epicenters. The present invention is based on the premise that a numeric analysis of large numbers of events is more efficient for computer processing than managing large sets of heuristic rules.

The present invention does not address how and where network/service topology is attained, or how it is stored. The present invention assumes that sufficient topology information can be mined from various network and service inventory and configuration sources. The present invention also assumes that this information can be represented and stored in a computer-based model that allows efficient management and access thereof.

Information models for telecom networks and services are commonplace, and are often used to represent equipment inventory, network/service topology, and information exchange across system interfaces. However, most models, particularly those defined by the standards community, consist of many object classes with many possible types of relationships between them. This leads to a high degree of complexity when used for event analysis, because there are simply too many interdependencies of too many types to support efficient, automated analysis. To alleviate this problem, the present invention proposes a simple skeletal approach that can be used to represent relationships between topology objects, i.e., network and service resources, or events. Unlike most existing solutions, which are limited to relatively flat topology models, the present invention is also able to scale up to sophisticated topologies for complex networks.

Current known methods of representing topologies do not support a simple mechanism for identifying the relative distance between objects or events. The present invention uses simple numeric indexing to represent the relative closeness between objects or events, and a matrix to map this relative closeness for multiple objects or events. The present invention improves the automation and consistency of event analysis over prior solutions. The present invention reduces the challenges of topology analysis to a numerical problem that can be processed and maintained more efficiently than rule sets and policies.

The matrix analysis approach of the present invention provides a numerical tool for event and object analysis instead of managing large sets of detailed per-event/per-object rules. Although complex logic is supported (and discussed later herein), it is not necessary for implementation of embodiments of the present invention. Unlike rules or policy-based applications, where more complex topologies can require more complex logic to analyze, the present invention can utilize the same analysis logic regardless of the complexity or completeness of the topology, and can provide effective results with incomplete event information as well.

Existing/prior solutions generally support a single event analysis algorithm, which is often hard-coded into the OSS. Conversely, the present invention provides a simple, consistent analysis of related events that can be used with any number of interchangeable applications. Multiple root cause, impact, dependency, and other event analysis applications (discussed herein below) can all use the same data. If desired, event-specific and object-specific rules/policies can still be added on top of the basic matrix analysis to provide additional customization and sophistication.

Rather than require a complex topology for event analysis, the present invention assumes the existence of a simple, skeletal model, which is expected to be distilled from various inventory, topology, and other data sources. In an embodiment, such a topology consists of objects representing network, service, and customer resources that are interconnected via two basic relationships: (a) connectivity (upstream/downstream), and (b) dependency (supports/supported by). As indicated, these relationships include directionality. However, if directional information is not sufficiently available, the topology model can still be used. However, embodiments of the present invention are not limited to two relationships. For example, additional relationships, if available, can also be supported (at the cost of added complexity) but are not necessary.

The matrix analysis approach of the present invention is primarily concerned with basic relationships between objects and events. Each object in the topology can be of any type or class, although it may be beneficial to flatten the class structure to improve consistency in assembling the model, especially if it is derived from different systems providing auto-discovery and inventory management. Class-specific attributes may also be helpful in supporting more sophisticated analysis logic (if desired), but are not required to produce useful results. This is deliberately done to simplify the task of assembling, storing, and traversing the topology for efficient event analysis. The more sophisticated the topology model is, the more sophisticated the model analysis of the present invention can be.

FIG. 1 is a diagram illustrating an example of a resource topology. The topology illustrated in FIG. 1 is an example of a customer's service that is supported by a two-layer network with service nodes (which are for voicemail or similar value-added services). Specifically, FIG. 1 illustrates a plurality of resource objects A through T in network 100. In network 100, resource object A is a customer, resource objects B and C are service instances (for example, wireline or wireless voice with value-added services), resource objects D and E are service nodes (for example, value-added service nodes, and resource objects F through T are network layers. However, embodiments of the present invention are not limited to the topology illustrated in FIG. 1, nor are embodiments of the present invention limited to the number and types of resource objects illustrated in FIG. 1, as the present invention is capable of being practiced with any type of topology, with any number of resource objects of any type. For simplicity and for purposes of discussion, the topology illustrated in FIG. 1 will be discussed throughout the subject application.

In FIG. 1, dependency relationships are shown vertically (with a single line), while connectivity relationships are shown horizontally (with a double line). In network 100, customer A is dependent upon service instances B and C. Service instance C is supported directly by the network, while service instance B is supported by value-added service nodes D and E. Service node D is supported by the network. The numbers in brackets, e.g., “[−3, −1]” in conjunction with network layer G, represent the relative distance a particular resource object is from customer A. In an embodiment of the present invention, customer A is used as the focal object; however, other embodiments of the present invention are not limited to customer A as the focal object, as any other network object in the topology may be used as the focal object.

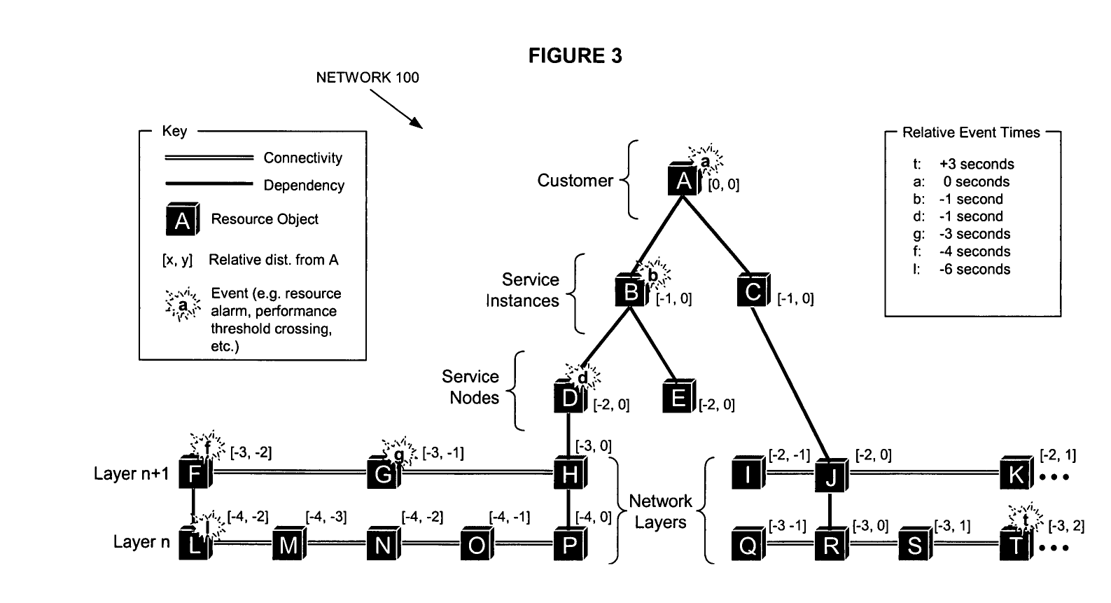

The present invention measures relative distance between objects/events as the number of relationship hops that they are away from one another in each dimension of the topology. Relative distance enumerates the relationship distance between objects or events, not physical distance. For purposes of the present invention, the absolute physical distance between objects or events is not particularly relevant, as only the closeness in terms of interconnection relationships is important. With this approach, software logic can be used to prioritize which events to troubleshoot first, identify in rank order the probable root alarms of a failure, and identify which objects are most likely to be impacted by a problem (discussed in more detail below). In the embodiment illustrated in FIG. 1, the notation used is: [d, c], where d and c represent the number of hops along the dependency and connectivity relationships between two objects or events. However, embodiments of the present invention are not limited to two dimensions, as any other number and types of dimensions may be used. For example, the dimension of time is discussed in conjunction with FIG. 3 (below), and would be indicated by the index t as follows: [d, c, t]. Any additional dimensions in the topology would have additional corresponding indices. In addition, the arrangement of indices, e.g., d before c, is not significant. The indices are integers, except for the event time dimension (discussed below), which can be represented as milliseconds, seconds, minutes:seconds, etc. However, the subject application refers only to integer seconds for simplicity. In addition, different topology complexities can also be supported. Although two dimensions are recommended (connectivity and dependency), a simple one-dimensional topology using only dependency will still enable event analysis—albeit to a lesser degree. Similarly, the same matrix approach can be used for three or more relationship types (each one adding a new dimension to the topology matrices). The added sophistication comes at a cost of higher complexity, and is not considered necessary, but it is important to note that the present invention is scalable to greater levels of topology sophistication.

In an embodiment of the present invention, positive integers represent downstream distances, while negative integers represent upstream distances. For example, network layer F in FIG. 1 has a relative distance of [−3, −2] from customer A, which indicates that network layer F is three dependency links downstream (through service instance B and service node D) and two connectivity links downstream (through network layer G). It should be noted that customer A has a relative distance of [0, 0], because customer A is the focal object in the illustrated embodiment, and therefore is zero dependency and connectivity hops away from itself. In another example, network layer T has a relative distance of [−3, 2] from customer A, which indicates that network layer T is three dependency links downstream (through service instance C and network layer J) and two connectivity links upstream (through network layer S). Obviously, different topologies will yield different relative distances, as will selecting a different focal object, and the present invention is not limited to any particular topology or focal object.

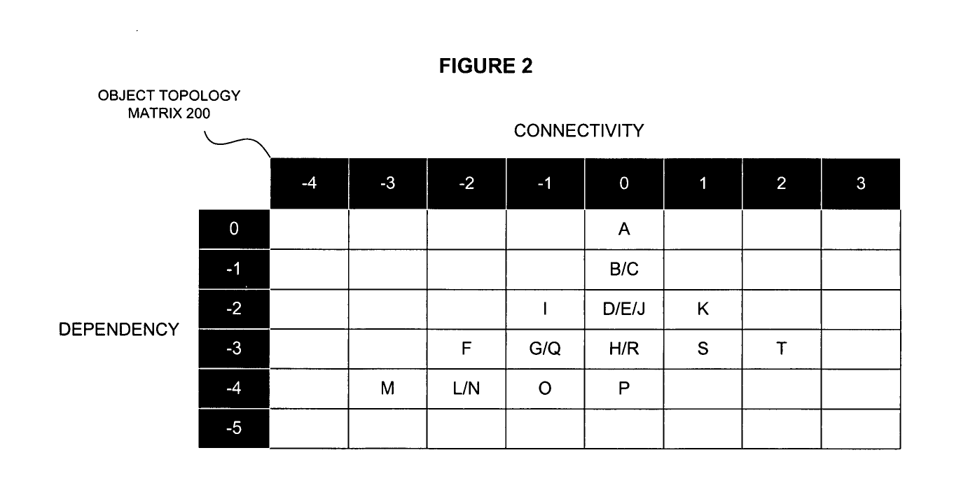

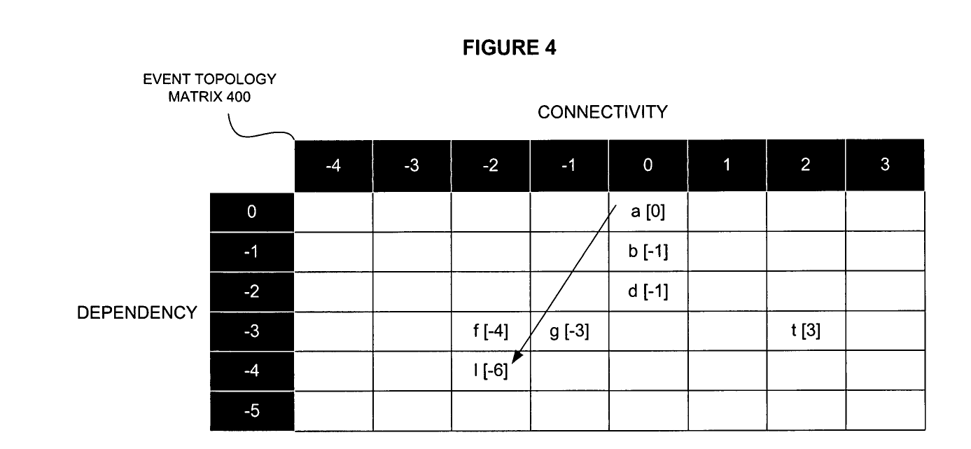

Quantifying relative distance is an important part of the present invention. However, because telecom service assurance typically involves large numbers of objects and events, an additional mechanism is needed to compare (and potentially display, discussed in greater detail below) the relative distances between many objects or events. Therefore, the present invention uses a matrix to represent relationships of multiple objects or events (depending on which type of topology is being mapped). Each cell in the matrix identifies objects or events of the given cell's relationship to a focal object/event. Each dimension of the matrix represents one type of relationship in the topology model. Therefore, in an embodiment of the present invention, a resource topology with connectivity and dependency relationships would use a two-dimensional matrix (see the discussion of FIG. 2, below), whereas an event topology with connectivity, dependency, and time relationships would use a three-dimensional matrix (see the discussion of FIG. 4, below). As stated previously, embodiments of the present invention are not limited to two or three dimensions.

The matrix is populated with identifiers of objects or events that are related to a reference object/event. In an embodiment, objects/events are filtered out of the matrix, which is useful for reducing clutter in the matrix. Various criteria may be employed for filtering, e.g., how relatively far away the objects/events are from the focal object/event, the type of event (e.g., loss-of-signal alarm), or the object class (e.g., routers). However, embodiments of the present invention are not limited to the above filtering examples, as any other filtering criteria may be used, e.g., events within 30 seconds of the focal event, all events on router-type objects within 10 minutes of the focal event, all downstream objects within 2 levels of dependency to the focal object, all performance threshold crossing events on upstream objects within one day of the focal event, etc.

FIG. 2 is a diagram illustrating an example of an object topology matrix according to the resource topology of FIG. 1. Specifically, object topology matrix 200 contains identifiers corresponding to the objects of network 100. In an embodiment, the columns of object topology matrix 200 indicate connectivity relationships, and the rows of object topology matrix 200 indicate dependency relationships. However, other embodiments of the present invention are not limited to any particular correspondence between relationships and columns/rows, nor is the present invention limited to the number of columns/rows illustrated in FIG. 2. In FIG. 2, identifiers A through T are illustrated in object topology matrix 200, identifier A residing at [0, 0] because it remains the focal object pursuant to the example discussed in connection with FIG. 1. Accordingly, if the focal object of network 100 in FIG. 1 changes, the organization of object topology matrix 200 will change therewith.

In addition, multiple identifiers may occupy a single space in the object topology matrix 200, because multiple objects in network 100 may have the same relative distance from the focal object. For example, referring back to FIG. 1, service instances B and C both have a relative distance of [−1, 0] from customer A. Therefore, in object topology matrix 200, identifiers B and C share the space at the intersection of connectivity column 0 and dependency row −1. While this phenomenon is illustrated several times in FIG. 2 (as a result of the topology of network 100), the likelihood of several events occupying the same space in an event matrix is much lower due to the additional dimension of time (see the discussion of FIG. 4 below).

In an embodiment of the present invention, an object can have its identifier located in multiple cells of the object topology matrix if its relative distance to the focal object is measured differently or along different paths. For example, network layer L in FIG. 1 is illustrated as having a relative distance from customer A of [−4, −2], because it is measured through network layers F and G as opposed to being measured through network layers M, N, and O. Accordingly, network layer L's identifier is illustrated in object topology matrix 200 in connectivity column −2 and dependency row −4. However, if network layer L were also to be measured through network layers M, N, and O, network layer L would have a second relative distance from customer A of [4, −4]. In that case, L's identifier would also be illustrated in object topology matrix 200 in connectivity column −4 and in dependency row −4. Although such a level of complexity is supported by the present invention, for purposes of discussion herein, only a single relative distance for each object/event is discussed, and therefore, each object of network 100 has only one identifier in object topology matrix 200.

As illustrated in FIG. 1 (discussed above), existing topology models typically represent the interconnection of network resources (objects), i.e., the topology models are resource (object) topologies. However, the present invention also analyzes events. An event topology consists of representations of events that have occurred on network/service resources (objects) or anything else contained in the resource topology, and focuses on a focal event. It does not include objects representing resources that do not have alarms or other events raised on their behalf. However, for purposes of continuity, FIG. 3 (discussed below) illustrates all of the objects in FIG. 1 regardless of whether the object has an event. Whereas the resource (object) topology is more static and includes all pertinent resources (objects) in the network, the event topology is highly transient. The event topology's constituents exist only as long as their respective events exist.

In an embodiment, the event topology utilizes the same relationships that were discussed in connection with the object topology (above), plus the added dimension of time. Like the other relationships, the time should also include directionality, i.e., before and after the focal event. In an event topology, the measure of relative distance is used in the present invention, for example, to identify event impact, root cause suspects, etc. (discussed in greater detail below). For example, consider a first event measured at [0, −15, −3] to the focal event (noting that the indices are the same as discussed above, but with the addition of a time index: [dependency, connectivity, time]). This first event is 15 connectivity hops upstream and 3 seconds before the focal event. Such a first event is further away from the focal event than a second event that is measured at [3, −6, 1], which is only 9 hops (3 dependency +6 connectivity) and 1 second away. However, the first event is in the same dependency layer (the first index is zero), it is connected upstream of the focal event (the second index is negative), and it happened three seconds before the focal event (the third index is negative). If both events represent network alarms, the present invention can safely assume that the first event at [0, −15, −3] is more likely to be a root alarm than the second event at [3, −6, 1], which actually happened after and downstream of the focal event (see discussion of root cause analysis below).

FIG. 3 is a diagram illustrating the resource topology of FIG. 1, overlayed with various events. Specifically, FIG. 3 again illustrates network 100 from FIG. 1, but also illustrates events that occur, in an embodiment, on the objects of network 100 within a 10 second window of event a that occurs on customer A, which is referred to herein as the focal event. Embodiments of the present invention are not limited to the focal event occurring on any particular network object, though, as any event may be chosen as the focal event. In addition, embodiments of the present invention are not limited to only illustrating events that occur within a 10 second window, as any filtering, or none at all, may be used as appropriate.

In the embodiment shown in FIG. 3, a failure at network layer L, e.g., a switch or router, generates an alarm, which is illustrated by event l on network layer L. Subsequent alarms are raised by network layers F, G, and T, and service node D, which are illustrated by events f, g, t, and d, respectively. Embodiments of the present invention are not limited to any specific number, dispersion, or arrangement of events or alarms, as any number, dispersion, or arrangement of events/alarms may exist. For example, there may exist an event on network layer H or service instance C in another embodiment. In an embodiment, these network objects are physical devices that emit alarm messages upon detection of some type of failure. In the embodiment, customer A and service instances B and C are logical objects, which may or may not actively emit events/alarms. However, alarms may still be raised on their behalf through active testing or inference, thus events a and b, as illustrated in FIG. 3. For example, in an embodiment, active testing can be used to measure the performance quality directly provided by the service instance or as delivered to the customer. If the measured quality falls below a set threshold, an alarm can be raised on their behalf. If this is not available, impact analysis (discussed in greater detail below) can be used to infer events on logical resources like services and customers. Because customer A and service instance B depend directly on the physical resources, the resource topology model can be used to infer failure alarms on them.

In FIG. 3, the relative event times are listed. The events occur in network 100 at various times, and are assigned a time stamp by network 100, which is, in an embodiment, a time of day and a date, such as Oct. 15, 2003—9:34 a.m. However, embodiments of the present invention are not limited to such a time-stamp format, as any time stamp format may be used. For example, a 24-hour time format may be used, the date may be omitted, etc. Time-stamping of events is well-known in the art, and will not be further discussed herein. The present invention simply relies on some form of global time-stamping of events. The time-stamped events are then normalized according to the focal event, which itself is normalized to a zero time. The normalization process is well-known in the art, and is performed simply to label each event with a time relative to the focal event. For example, in the embodiment illustrated in FIG. 3, event a (the focal event) is normalized to zero seconds, event t is normalized to +3 seconds (because event t occurred 3 seconds after focal event a), event b is normalized to −1 seconds (because event b occurred 1 second before focal event a), etc. Embodiments of the present invention are not limited to normalizing the relative times to integers, as any unit of time measurement may be used, and fractional relative times are easily foreseeable. For example, if seconds are again selected, another event (for example, a new event x) may have a relative time of +0.45 seconds if event x occurred 0.45 seconds after focal event a. In another example, if milliseconds are selected, yet another event (for example, a new event y) may have a relative time of −62 milliseconds if event y occurred 62 milliseconds before focal event a. It should be noted that if another focal event is chosen, the plurality of events will be normalized again relative to the new focal event based on each event's global time stamp.

FIG. 4 is a diagram illustrating an example of an event topology matrix according to the resource topology and events of FIG. 3. As with object topology matrix 200, event topology matrix 400 lists connectivity relationships as columns and dependency relationships as rows. However, embodiments of the present invention are not limited to such a matrix configuration, as different relationships may be illustrated, and in a different configuration. Specifically, event topology matrix 400 contains the events illustrated in FIG. 3. As compared to object topology matrix 200 in FIG. 2, event topology matrix 400 is less populated, because event topology matrix 400 does not include objects without events. This difference is likely to be more pronounced in larger networks, where event filtering (as described above) can be used to keep the ratio of examined/mapped events to existing resource objects low. Intelligent filtering is an important part of the present invention for efficient large-scale event analysis. Also, while each cell in event topology matrix 400 can hold multiple events (similar to cells in object topology matrix 200 containing multiple objects, as discussed above), the likelihood is much lower due to the additional dimension of time.

In FIG. 4, events a, b, d, f, g, l, and t are illustrated. Each event resides in the same location in the event topology matrix 400 that the object on which it occurred resides in the object topology matrix 200, e.g., event g resides in the cell located at a connectivity of −1 and a dependency of −3 in the event topology matrix 400, and network layer G resides in the cell located at a connectivity of −1 and a dependency of −3 in the object topology matrix 200. This is because each event still occurs at the same relative distance from the focal event. However, in regard to FIGS. 3 and 4, the added dimension of time is indicated (as discussed above). Therefore, each event is listed in the event topology matrix 400 with its associated relative time as well. For example, event f resides at a connectivity of −2 and a dependency of −3 (similar to network layer F), and is also indicated as having a relative time of −4, i.e., having occurred four seconds before focal event a. In another example, event b resides at a connectivity of zero and a dependency of −1, and is also indicated as having a relative time of −1. Embodiments of the present invention are not limited to any particular matrix contents, as different choices in filtering and focal event designation will alter the contents of event topology matrix 400.

In an embodiment, a conclusion that can be drawn from event topology matrix 400 is that event l is the most upstream event from focal event a. Specifically, event l occurs 6 seconds before focal event a at a relative distance of [−4, −2] from focal event a. While event t (the other leaf-node event) is logically closer to focal event a (having a relative distance of [−3, 2]), event t occurs 3 seconds after focal event a. Therefore, a process that finds suspected root events by identifying the most upstream alarm (including upstream/before in time) would select event l as the likely root event (determining root cause events is discussed in greater detail below). Event l is also at the end of a direct chain of events to focal event a. Although discussed in greater detail below, an event vector originating at focal event a and terminating at event l is illustrated in FIG. 4 by an arrow from the cell containing focal event a to the cell containing event l. The other leaf-node event, event t, is not judged as a possible root cause because event t does not lie on a clear event vector, is downstream from focal event a, and can reasonably be judged to be unrelated to focal event a.

Once the topology can be measured and events mapped into a matrix, any application logic can be used to analyze the results. This provides a consistent mechanism for the numeric measurement and comparison of events, on top of which multiple applications with different event or topology analyses can be applied. Example analyses include the following groups—each of which can support multiple implementations:
Impact analysis—traversing object topology matrix 200 to determine what network objects are affected by a failure or performance drop. This can be used to prioritize which failures should be corrected first. In an embodiment, failures on resources that do not directly support customer services can be handled at a lower priority than those that do. However, embodiments of the present invention are not limited to only one use for impact analysis, as such an analysis may be used for many different purposes.
Root cause analysis—identifying and prioritizing suspected root alarms or root causes to a problem based on event topology matrix 400. This will be examined in more detail below.
Sympathetic event reduction—identifying related events, correlating them to a master event (e.g. one representing an affected customer or service), and hiding the redundant “sympathetic” events.
Dependency analysis—traversing object topology matrix 200 to find common network object dependencies. Whereas impact analysis is performed bottom-up (i.e. identifying impacted objects from lower-level problems), dependency analysis searches for common dependencies or weak points in the topology. This can be used by network engineers to increase the reliability and fault tolerance of network objects.
Predictive analysis—performing impact analysis in a predictive manner by using hypothetical failures to determine what objects would be affected by potential problems. This can also used by network engineers to increase the reliability and fault tolerance of network objects.

Traditional solutions use hard-coded the algorithms or sets of complex scripts and heuristic rules. These are difficult to maintain and offer limited means of version control and migration. The solution described in the present invention supports different levels of sophistication of the event or topology analysis. Simple logic is all that is required to get started, but more complex logic—even those with heuristic rules—can also be included and coexist. For example, a service provider might use a simple process to narrow the set of examined alarms/events, followed by a more sophisticated process to pinpoint the root cause (root cause analysis is discussed in more detail herein).

The discussion of FIG. 4 introduced the concept of an event vector. An event vector is a set of events along a path of related objects from a base, at the most upstream connected event, to the focal event on the most downstream affected object (e.g., a service or customer). In event topology matrix 400, the only clear event vector consists of events l (the base), f, g, d, b, and a (the endpoint). However, embodiments of the present invention are not limited to a single event vector, and the discussion and analysis of a single event vector herein result only from the example objects and events illustrated in FIGS. 1 and 3. The vector should be as complete as possible, although it should not be assumed that every object in line between the base and endpoint has events raised. In addition, for the event vector to provide convincing evidence of a root cause, all the events along the vector should be of a compatible type (though not necessarily identical). In an embodiment, a particular event is included in multiple event vectors.

In an embodiment of the present invention, basic root-cause analysis would comprise the following operations: First, a focal event of interest would be selected. This can be accomplished in several ways, manually by an operator or automatically: (a) from a given event, by performing an impact analysis using object topology matrix 200 to determine the highest-level object that is affected by the event (in some cases, this may already be known from a service test or a customer complaint), (b) by selecting an alarm/event from a set of alarms/events, e.g., a network alarm, a performance threshold crossing, a service level agreement (SLA) violation, or an active service test, or (c) selecting an object that is determined to be in trouble via a customer care process, e.g., a customer calling in a complaint. For example, in FIGS. 1-4, event a has been used as the focal event. Next, event topology matrix 400 would be examined from the perspective of the focal event, using filtering if desired to avoid unnecessary clutter in the event topology matrix 400. Then, leaf-node events and the event vectors from the event topology matrix 400 are identified. For example, returning to FIGS. 1-4, events l and t are identified as leaf-nodes, and event vectors are identified; however, the event vector between focal event a and event t is not illustrated in FIG. 4. Next, root cause suspects are ranked according to policy or selected criteria. The highest ranked root suspect is likely to be the longest, most complete event vector that has an upstream root event; however, the present invention is not limited to a single ranking policy, as other ranking policies can also be used. For example, in an embodiment, ranking factors may include:
The “angle” of the event vector, or how directly in line the event vector is with a given relationship. For example, in an embodiment, a sophisticated ranking policy is created that weighs event vectors closer to a given relationship (e.g., all connectivity alarms) higher than those that follow a mix of relationships (e.g., a mix of connectivity and dependency events). The more closely aligned a vector is with a single relationship, the more consistent the events are likely to be.
The time dispersion of events along the event vector. In an embodiment, event vectors with events that occurred closer together could be ranked higher than those event vectors with dispersed times.
The consistency of the types of events. In an embodiment, event vectors with consistent alarms (e.g., loss of signal) could be ranked higher than those with a mix of problem types.
   The root suspect ranking policies listed above are shown as examples of the level of sophistication that can be supported by the present invention. Most other solutions, including codebooks, cannot do the same and are often limited to simple, one-dimensional, fixed methods. If desired (and especially for initial deployments), the present invention can provide this same level of simplicity. Next, the base events of suspected root problems are presented in ranked order (if there is more than one suspected root problem). Finally, events between the base and endpoint events of the event vector(s) are suppressed.

Telecommunications networks are often complex. The volume of events—particularly when large failures occur—is often high, and the consistency of network topology data can be relatively low. Given these conditions, it is important for the event analysis process to support varying degrees of complexity and uncertainty. The present invention can provide useful results with a range of available information. The more complete and reliable the topology is, the more conclusive the results will be. However, even with limited topology information, the present invention can still identify resource dependencies and prioritize events that are more likely to indicate root problems than others. This is another advantage over rules or policy-based applications, where incomplete information or more complex topologies require more complex rules/policies to analyze. The present invention can utilize the same simple process logic regardless of the complexity or completeness of the topology.

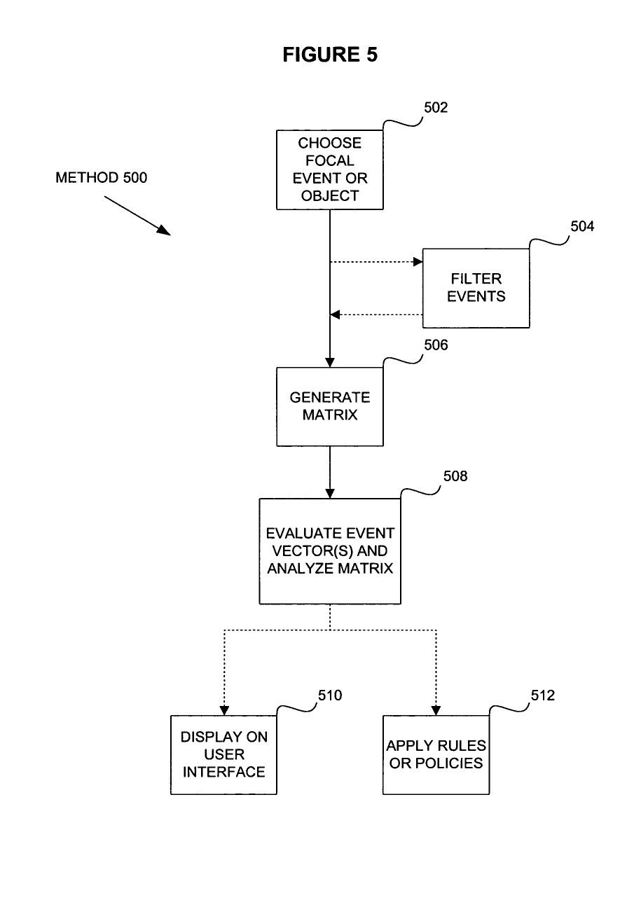

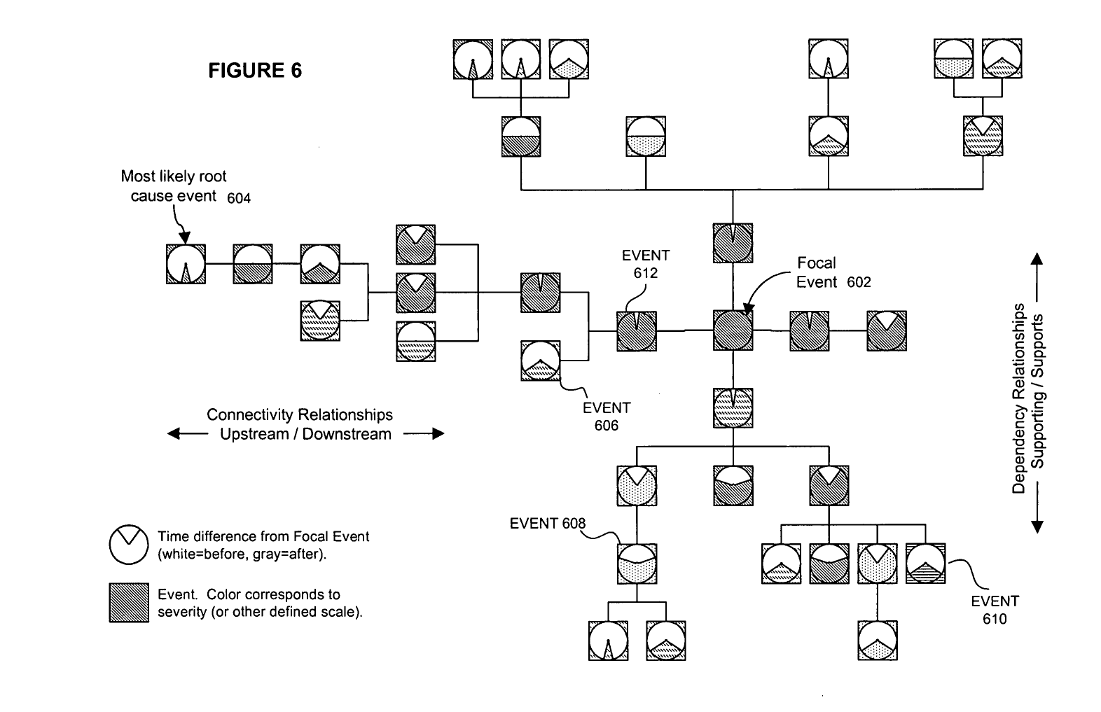

FIG. 5 is a flowchart illustrating a method and machine-readable medium for automatically analyzing network events using matrices, according to embodiments of the present invention. An important pre-condition to the flow in FIG. 5 is that the topology has already been (or readily can be) put into a format suitable to the matrix technique, i.e., the topology has been “normalized” into a set of consistent relationships (connectivity and dependency have been discussed herein, but more relationships are possible, as discussed above) between objects. As illustrated in FIG. 5, method 500 comprises several operations, beginning with operation 502, which includes choosing the focal event or object. As discussed above, operation 504, filtering events, is optionally performed. In operation 506, an object topology matrix or an event topology matrix is generated and populated. In operation 508, event vectors are evaluated and the matrix is analyzed according to one of the protocols discussed above. In operation 510, the results are optionally displayed on a user interface, which is discussed in greater detail below in regard to FIGS. 6-8. In operation 512, rules or policies are optionally applied to the analysis, if required.

The matrix analysis approach of the present invention can also be used to drive user interface (UI) displays of events and their relationships (e.g. via OBJECT BROWSER). In an embodiment, the UI is a graphical user interface (GUI). The displays of the present invention (as illustrated in FIGS. 6-8) are not static displays. In an embodiment, the displays are dynamic, because the displays change as focal events change, as filtering changes, as analysis methods are changed, etc. The displays are useful in providing operators with a connectivity view of related events to a selected focal event. An example of this is illustrated herein in FIG. 6.

FIG. 6 is a diagram illustrating a display of network events on a GUI, according to embodiments of the present invention. In an embodiment as illustrated in FIG. 6, focal event 602 at the center of the display can either be selected from a separate UI (e.g., an alert list display), or from the event relationship display itself (e.g., where a newly-selected event becomes the new focal event of the display). Each event is illustrated by an icon, which as illustrated is a square; however, any type of icon may be used. For example, other geographic shapes may be used, e.g., a circle, triangle, trapezoid, etc., an animated icon may be used, etc. The lines connecting various events illustrate some object information, because they show how events (which reside on objects) are connected based on how the objects are laid out; however, the icons are not intended to illustrate complete object information, i.e., the icons refer only to events, and from the knowledge of the event and its relationship to other events, information about various objects may be derived. In an embodiment, the thickness or composition of the lines connecting events is varied to illustrate a difference in rank (but different line thickness or composition is not illustrated in FIG. 6). For example, in an embodiment, a thicker line is used to indicate a higher rank, while a dashed line is used to indicate a lower rank.

In an embodiment, icon colors correspond to alert/event severity. For example, as illustrated in FIG. 6, diagonal lines beginning at the upper left of the icon and ending at the lower right of the icon symbolize the color red; diagonal hashes beginning at the upper left of the icon and ending at the lower right of the icon symbolize the color orange; a polka-dot pattern symbolizes the color yellow; and horizontal lines symbolize the color green. For example, focal event 602 is illustrated in FIG. 6 as being colored red, event 606 is illustrated as being colored orange, event 608 is illustrated as being colored yellow, and event 610 is illustrated as being colored green. However, embodiments of the present invention are not limited to red, orange, yellow, and green, as any other colors may be used.

In addition, clock-like arcs may be used to represent each particular event's relative time difference from focal event 602. For example, focal event 602 has a clock-like arc that indicates no relative time difference, event 612 has a clock-like arc that indicates a slight relative time difference, i.e., the arc is almost completely filled, and event 606 has a clock-like arc that indicates a relative time difference that is greater than that of event 612, i.e., the arc of event 606 is more open than that of event 612, and most likely root cause event 604 has a clock-like arc that indicates a relative time difference that is greater than that of events 606 and 612. Further, the colors white gray are used to distinguish between events that occur before and after focal event 602. Specifically, as illustrated in FIG. 6, a white arc coloring is used to indicate that an event occurred before focal event 602, e.g., most likely root cause event 604 and events 608 and 612, and a gray arc coloring is used to indicate that an event occurred after focal event 602, e.g., events 606 and 610. However, embodiments of the present invention are not limited to white and gray, as any two colors may be used.

In addition, FIG. 6 also identifies most likely root cause event 604. Most likely root cause event 604 is the most upstream related event to the focal event, and represents the base of the longest event vector using the root cause analysis approach described above. Embodiments of the present invention are not limited to most likely root cause event 604 being exactly as illustrated in FIG. 6 (in regard to severity, relative time, dependency, or connectivity), as a different choice of focal event 602 or different filtering protocols may alter the selection of most likely root cause event 604.

Embodiments of the present invention are not limited to the configuration of events/icons as illustrated in FIG. 6, as a different choice of an event as focal event 602 and different filtering protocols may alter the displayed events and their arrangement. Of course, the look and feel of the example UI of FIG. 6 can be altered to meet any desired UI conventions. A variety of other features can also be added to drill down into specific events or expand the view around multiple focal events. These types of features are common for most topology-based event viewers, and are therefore not discussed further herein. Some of the advantages of the present invention over the previous solutions are:
The contents of the display are driven by the event matrix. This provides the filtering or selection criteria for what events to show, and how they are related. The display does not present objects that do not have events raised on their behalf, nor does the display show events that are not related to the focal event (e.g., not on an event vector, as discussed above). This allows the user to focus in on and view only related events to the focal event (possibly a root problem).
The display shows a hybrid dependency (tree)/connectivity (link) style display.
The display is intended to show relationships between events themselves, not necessarily all events everywhere. The value of this approach is that it allows operators to visually examine correlated events, without the clutter of other unrelated happenings in the network.
The time arc in each icon allows users to easily see the time dependencies between related events.

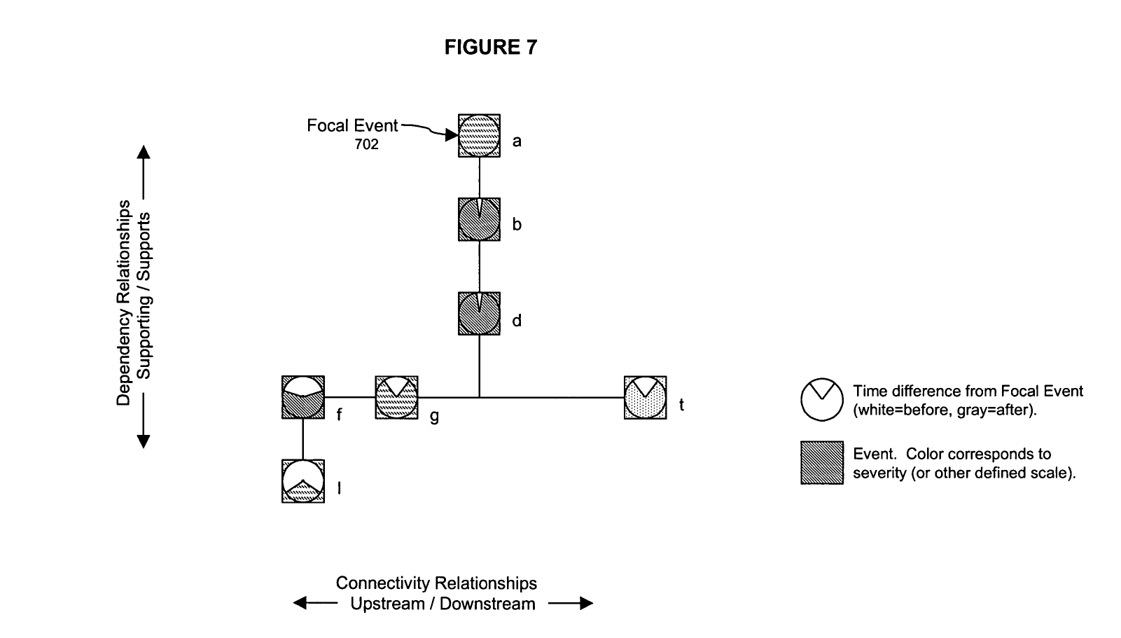

A similar matrix-based display can be used to show events affecting an individual customer or service. FIG. 7 is a diagram illustrating a display of the network events of FIG. 3 on a GUI, according to embodiments of the present invention. Specifically, FIG. 7 illustrates the display for event topology matrix 400 of FIG. 4. In this case, focal event 702 has an icon that is marked as icon a to represent event a on customer A from the illustration in FIG. 3. Also illustrated are icons b, d, f, g, l, and t to represent events b, d, f, g, l, and t, as discussed in connection with FIGS. 3 and 4 above. The likely root alarm is event l, as discussed previously, which the user can see is the furthest upstream event in a chain of events leading to the customer outage event a. In the event matrix analysis, event l would be the base of the longest upstream event vector. However, embodiments of the present invention are not limited to the particular configuration of displayed events, as a different event topology matrix 400, e.g., if a different focal event or a different filtering protocol is used, may be supplied for display.

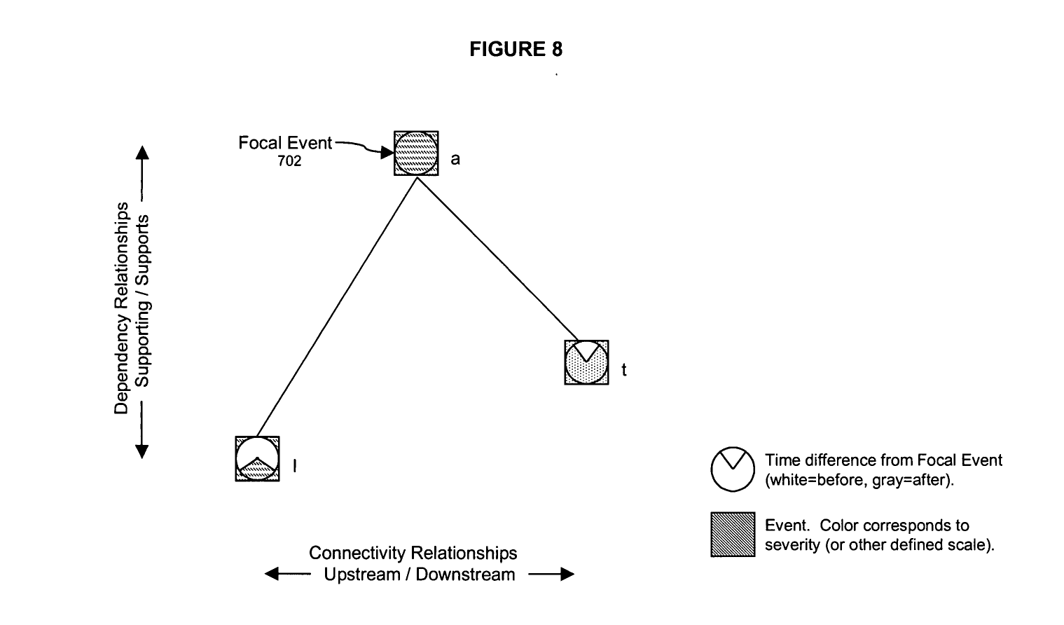

In an embodiment, if the contents of event topology matrix 400 are very large, the corresponding display of the contents in FIG. 7 would be very cluttered. The present invention provides for the display of only a summary of the events contained in event topology matrix 400. FIG. 8 is a diagram illustrating another display of the network events of FIG. 3 on a GUI, according to embodiments of the present invention. Specifically, FIG. 8 illustrates only icons representing events a (focal event 702), l, and t, with lines (representing the respective event vectors) connecting events a and l, and events a and t. Essentially, the display illustrated in FIG. 8 illustrates only the focal event and any leaf-node events. All of the intermediate events have been removed from the display to simplify the viewing thereof for a user. For certain types of analysis such as root cause analysis, if there are a lot of leaf-nodes, i.e., potential root causes, an operator will prefer to examine only the leaf-nodes and the resulting event vectors, and a display of the type illustrated in FIG. 8 will be helpful.

For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method for automatically analyzing network events, comprising:
generating a matrix that illustrates relationships between a plurality of network events and a focal event from the plurality of network events or that illustrates relationships between a plurality of network objects and a focal object from the plurality of network objects; and
automatically analyzing the matrix by evaluating at least one event vector.

2. The method of claim 1, wherein the matrix is based in part on a resource topology or an event topology.

3. The method of claim 1, wherein the matrix illustrates connectivity relationships among the plurality of network objects.

4. The method of claim 1, wherein the matrix illustrates dependency relationships among the plurality of network objects.

5. The method of claim 1, wherein the matrix illustrates time relationships between the plurality of network events and the focal event.

6. The method of claim 1, wherein the matrix illustrates a relative distance among the plurality of network events or the plurality of network objects.

7. The method of claim 1, further comprising:
filtering the plurality of network events before generating the matrix.

8. The method of claim 1, further comprising:
applying event-specific or object-specific rules or policies to a result of the analysis of the matrix.

9. The method of claim 1, wherein the matrix is populated with identifiers of the plurality of network objects or identifiers of the plurality of network events.

10. The method of claim 1, wherein the at least one event vector is a set of network events from the plurality of network events along a path of related network objects from the plurality of network objects.

11. The method of claim 1, wherein the automatic analyzing comprises a sympathetic event reduction, which comprises:
identifying at least one related event from the plurality of network events;
correlating the at least one related event to the focal event; and
hiding at least one redundant sympathetic event from the plurality of network events.

12. The method of claim 1, wherein the automatic analyzing comprises a dependency analysis, which comprises locating common dependencies among the plurality of network objects.

13. The method of claim 1, wherein the automatic analyzing comprises an impact analysis, which comprises determining which of the plurality of network objects are affected by the focal event.

14. The method of claim 1, wherein the automatic analyzing comprises a predictive analysis, which comprises determining which of the plurality of network objects would be affected by a hypothetical focal event.

15. The method of claim 1, wherein the automatic analyzing comprises a root cause analysis, which comprises identifying and prioritizing at least one suspected root event from the plurality of network events as a potential root cause of the focal event.

16. The method of claim 15, wherein the identifying and prioritizing the at least one suspected root event comprises:
identifying at least one leaf-node event from the plurality of network events;
ranking the at least one leaf-node event according to ranking factors; and
suppressing each of the plurality of network events that are in the at least one event vector and that are not the focal event or the at least one leaf-note event,
wherein the ranking factors comprise the angle of the at least one event vector, a time dispersion along the at least one event vector, and a consistency of event types along the at least one event vector.

17. The method of claim 1, further comprising:
displaying the focal event, at least one other event of the plurality of network events, and the relationships between the focal event and the at least one other event on a user interface,
wherein each of the displayed plurality of network events is displayed as one of a plurality of network event icons in one of a plurality of colors to indicate event severity, and
wherein each of the displayed plurality of network event icons is displayed with a clock-like arc in one of two colors to represent a time relationship as compared to the focal event.

18. The method of claim 17, wherein the displaying is static or dynamic.

19. The method of claim 17, wherein only the focal event and at least one leaf-node event from the plurality of network events are displayed.

20. The method of claim 17, wherein the relationships are illustrated with a plurality of lines connecting at least two of the displayed plurality of network events.

21. The method of claim 20, wherein the plurality of lines vary in thickness and composition to illustrate rank.

22. A machine-readable medium that provides instructions for automatically analyzing network events, which, when executed by a machine, cause the machine to perform operations comprising:
generating a matrix that illustrates relationships between a plurality of network events and a focal event from the plurality of network events or that illustrates relationships between a plurality of network objects and a focal object from the plurality of network objects; and
automatically analyzing the matrix by evaluating at least one event vector.

23. The machine-readable medium of claim 22, wherein the matrix is based in part on a resource topology or an event topology.

24. The machine-readable medium of claim 22, wherein the matrix illustrates connectivity relationships among the plurality of network objects.

25. The machine-readable medium of claim 22, wherein the matrix illustrates dependency relationships among the plurality of network objects.

26. The machine-readable medium of claim 22, wherein the matrix illustrates time relationships between the plurality of network events and the focal event.

27. The machine-readable medium of claim 22, wherein the matrix illustrates a relative distance among the plurality of network events or the plurality of network objects.

28. The machine-readable medium of claim 22, wherein the instructions cause the machine to perform operations further comprising:
filtering the plurality of network events before generating the matrix.

29. The machine-readable medium of claim 22, wherein the instructions cause the machine to perform operations further comprising:
applying event-specific or object-specific rules or policies to a result of the analysis of the matrix.

30. The machine-readable medium of claim 22, wherein the matrix is populated with identifiers of the plurality of network objects or identifiers of the plurality of network events.

31. The machine readable medium of claim 22, wherein the at least one event vector is a set of network events from the plurality of network events along a path of related network objects from the plurality of network objects.

32. The machine-readable medium of claim 22, wherein the automatic analyzing comprises a sympathetic event reduction, which causes the machine to perform operations comprising:
identifying at least one related event from the plurality of network events;
correlating the at least one related event to the focal event; and
hiding at least one redundant sympathetic event from the plurality of network events.

33. The machine-readable medium of claim 22, wherein the automatic analyzing comprises a dependency analysis, which comprises locating common dependencies among the plurality of network objects.

34. The machine-readable medium of claim 22, wherein the automatic analyzing comprises an impact analysis, which comprises determining which of the plurality of network objects are affected by the focal event.

35. The machine-readable medium of claim 22, wherein the automatic analyzing comprises a predictive analysis, which comprises determining which of the plurality of network objects would be affected by a hypothetical focal event.

36. The machine-readable medium of claim 22, wherein the automatic analyzing comprises a root cause analysis, which comprises identifying and prioritizing at least one suspected root event from the plurality of network events as a potential root cause of the focal event.

37. The machine-readable medium of claim 36, wherein the identifying and prioritizing the at least one suspected root event causes the machine to perform operations comprising:
identifying at least one leaf-node event from the plurality of network events;
ranking the at least one leaf-node event according to ranking factors; and
suppressing each of the plurality of network events that are in the at least one event vector and that are not the focal event or the at least one leaf-note event,
wherein the ranking factors comprise the angle of the at least one event vector, a time dispersion along the at least one event vector, and a consistency of event types along the at least one event vector.

38. The machine-readable medium of claim 22, wherein the instructions cause the machine to perform operations further comprising:
displaying the focal event, at least one other event of the plurality of network events, and the relationships between the focal event and the at least one other event on a user interface,
wherein each of the displayed plurality of network events is displayed as one of a plurality of network event icons in one of a plurality of colors to indicate event severity, and
wherein each of the displayed plurality of network event icons is displayed with a clock-like arc in one of two colors to represent a time relationship as compared to the focal event.

39. The machine-readable medium of claim 38, wherein the displaying is static or dynamic.

40. The machine-readable medium of claim 38, wherein only the focal event and at least one leaf-node event from the plurality of network events are displayed.

41. The machine-readable medium of claim 38, wherein the relationships are illustrated with a plurality of lines connecting at least two of the plurality of network events.

42. The machine-readable medium of claim 41, wherein the plurality of lines vary in thickness and composition to illustrate rank.
